(19) United States
(12) Patent Application Publication
(10) Pub. No.: US 2025/0269889 A1
(43) Pub. Date: Aug. 28, 2025

(54) Bilateral Dumping Cart

(71) Applicants: Chen Dexin, Bangkok (TH); Eric Gagnon, Bangkok (TH); Nicholas Pieschel, Bangkok (TH)

(72) Inventors: Chen Dexin, Bangkok (TH); Eric Gagnon, Bangkok (TH); Nicholas Pieschel, Bangkok (TH)

(21) Appl. No.: 18/589,166

(22) Filed: Feb. 27, 2024

(51) Int. Cl. B62B 3/00; B62B 3/08

(52) U.S. Cl. CPC B62B 3/007; B62B 3/08

(57) ABSTRACT

The present invention relates to a bilateral dumping cart, designed to enhance material transportation and disposal efficiency. The cart comprises a bed supported by a frame, a pair of axles connected to the frame, and a set of wheels attached to each axle. A dumping mechanism facilitates the bed's connection to the frame, allowing for secure transport when in a locked configuration. The mechanism provides for bilateral dumping, enabling the bed to pivot and unload materials from either side of the cart. This feature is particularly advantageous in constrained spaces or uneven terrain where repositioning the cart for rear dumping is impractical. The structural design makes the cart suitable for various applications in different environmental conditions.

### BACKGROUND OF THE INVENTION

The present disclosure relates generally to a bilateral dumping cart. More particularly, the present disclosure relates to a dump cart and mechanism that provides for disposal of contents from the right and left sides of cart, instead of the rear of the cart.

In the field of material transportation and disposal, conventional dump carts are limited by their design to rear-only dumping capabilities. This restriction often results in inefficiencies and maneuverability challenges, particularly in constrained or uneven environments where reversing the cart is not feasible. The shortcomings of rear-only dumping carts extend beyond inefficiencies and maneuverability challenges. Such carts often require significant clearance behind them to offload contents, which is impractical in tightly packed spaces. Additionally, the manual user or operator of a vehicle pulling the cart may need to perform multiple repositioning maneuvers to align the cart correctly for dumping, which is time-consuming and can contribute to physical strain and increased risk of accidents. Attempts to overcome these issues have included the development of swivel beds and multi-directional dumping systems. However, these solutions often introduce complex mechanisms that can be prone to failure and require regular maintenance. They may also add to the overall weight and cost of the cart, diminishing their practicality and accessibility for many users.

Therefore, what is needed is a bilateral dumping cart having all of the further described features and advantages.

### SUMMARY OF THE INVENTION

The subject matter of this application may involve, in some cases, interrelated products, alternative solutions to a particular problem, and/or a plurality of different uses of a single system or article.

In one aspect, a bilateral dumping cart is disclosed. In this aspect, the bilateral dumping cart has a front, a rear, a left side, and a right side. The cart has a bed supported by a frame, and a pair of axles connected to the frame. Each one of the pair of axles has its own set of wheel, and the cart also includes a dumping mechanism located on at least one of its left side or its right side.

In another aspect, a side dumping mechanism is disclosed. In this aspect, the side dumping mechanism includes a handle connected to a rod. The rod extends through two annular bands a first and a second. The side dumping mechanism is connected to a bilateral dumping cart, which has a frame.

These aspects of the invention are not meant to be exclusive and other features, aspects, and advantages of the present invention will be readily apparent to those of ordinary skill in the art when read in conjunction with the following description, appended claims, and accompanying drawings.

### BRIEF DESCRIPTION OF DRAWINGS

FIG. 1 provides a perspective view of an embodiment of the cart according to the present disclosure.

FIG. 2 provides a perspective view of an embodiment of the cart in a right side dumping configuration.

FIG. 3 provides a perspective view of an embodiment of the cart in a left side dumping configuration.

FIG. 4 provides a perspective view of an embodiment of a dumping mechanism in a locked configuration.

FIG. 5 provides a perspective view of an embodiment of the dumping mechanism disconnected from the cart frame.

FIG. 6 provides a close up view of an embodiment of the dumping mechanism disconnected from the cart frame.

FIG. 7 provides a close up view of another embodiment of the dumping mechanism in an unlocked configuration.

FIG. 8 provides a perspective view of another embodiment of the dumping mechanism disconnected from the frame of a dumping cage.

### DETAILED DESCRIPTION OF THE INVENTION

The detailed description set forth below in connection with the appended drawings is intended as a description of presently preferred embodiments of the invention and does not represent the only forms in which the present disclosure may be constructed and/or utilized. The description sets forth the functions and/or the sequence of steps for constructing and operating the invention in connection with the illustrated embodiments.

Furthermore, in the context of the present disclosure, it is to be understood that relative terms, including, but not limited to, “front,” “rear,” “left,” “right,” and the like are used only as descriptors for convenience and to aid in the description of the bilateral dumping cart and its components. These terms are not intended to demarcate an absolute direction or orientation. Instead, they serve to provide a clearer understanding of the positions and relationships between various parts of the cart as typically viewed by a user operating or interacting with it. The use of these terms should not be construed to limit the components of the cart to any specific orientation or configuration. It is contemplated that the bilateral dumping cart and its components can be configured and used in various orientations, depending on the specific requirements of the application or the preferences of the user. Thus, relative terms are not to be considered limiting with respect to the possible orientations of the bilateral dumping cart and its components.

Generally, the present disclosure concerns a bilateral dumping cart with reciprocal dumping mechanisms providing for disposal of contents from both the right and left sides of cart. In most embodiments, the cart may comprise a bed supported by a frame, a pair of axles connected to the frame, and a set of wheels attached to each axle. In some embodiments, at least one of the dumping mechanisms may facilitate the bed's connection to the frame while also enabling the bed to pivot and unload materials from either side of the cart.

The bilateral dumping cart unexpectedly solves a significant problem with conventional rear dump carts. For example, the ability to offload materials from either side of the cart as opposed to the rear significantly enhances operational flexibility for unskilled users. Particularly, when pulling a traditional rear dump cart with an all-terrain vehicle (“ATV”), specialized skills are required to reverse the dump cart into a proper dumping position. The bilateral dumping cart eliminates the complexity and maneuvering typically associated with reversing the ATV with a cart attached, by simply allowing the user to reverse straight backwards. This augments the versatility of the cart for various tasks across the construction, landscaping, and agricultural industries.

In one embodiment, the cart may include a dumping bed, designed to carry a substantial volume of materials, and a robust frame may support the bed. The frame may utilize high-strength materials to ensure structural integrity. The structural integrity of the cart may allow for the bilateral dumping functionality of the cart, which may be facilitated by dumping mechanisms on both sides of the cart.

The cart's mobility may be enabled by durable wheels connected to a pair of arched axles attached to the frame. One of the axles may be situated near the front and the other towards the rear of the frame, enhancing the load distribution and stability of the cart. The arch structure may optimize ground clearance while maintaining a low center of gravity, which may also improve the balance and maneuverability of the cart. The wheels may be manufactured from materials capable of withstanding various terrains.

A handle may be pivotally connected to a bar protruding from the front axle by an elongate shaft. In one embodiment, the handle may be convertible and serve a dual purpose. One purpose may be to facilitate manual pulling of the cart by hand for precise placement of the cart. Another purpose of the convertible handle may be to enable towing by an ATV, especially when transporting heavier loads over more significant distances.

In most embodiments, the cart may be equipped to enter a dumping configuration on either side of the cart by two side dumping mechanisms. When in a locked configuration, the side dumping mechanisms may include a handle bent under the frame on either a left or a right side of the cart, effectively locking the mechanisms in place. The handle may be connected to a rod, which may extend through two annular bands. The bands may be attached to the dumping bed and the frame, respectively. The bands may also be cylindrical and define lengthwise circular apertures. This may hold the rod in place and prevent lateral movement, contributing to the locked configuration.

To unlock a mechanism, the handle may be lifted, which may remove the bent part of the handle from under the frame. The action may cause the rod to laterally rotate within the bands. The rotation may be stopped by the bent part of the handle coming into contact with the dumping bed after approximately ninety degrees (90°). At this point, the distal end of the rod may be removed from the annular band attached to the cart's frame, allowing the bed to be angled into a dumping configuration by continuing to lift the handle.

In another embodiment, the cart may include an annular band positioned inside the frame, as opposed to over it. This internal positioning of the annular band may encapsulate the rod and ensure minimal lateral movement. This embodiment of the cart may also include a dumping cage instead of a dumping bed. In this embodiment, the bottom of the dumping cage may prevent over-rotation of the dumping mechanism's handle, similar to the dumping bed. This may provide the leverage needed to transition the cage to a dumping configuration.

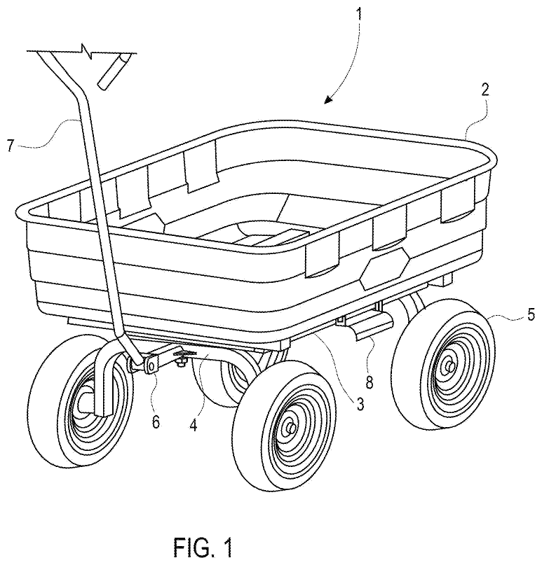

Turning now to FIG. 1, which provides a perspective view of one embodiment of the cart 1. The cart 1 includes a dumping bed 2 positioned atop a frame 3. The dumping bed 2 is characterized by its ample volume and reinforced structure, designed to carry heavy loads while facilitating efficient dumping. The frame 3 is engineered for stability and durability, potentially utilizing high-strength materials such as steel or aluminum alloy to ensure long-term structural integrity.

Two arched axles 4 are affixed firmly to the frame 3. One of the arched axles 4 is situated proximate to the front and other pair is positioned at the rear of the frame 3, which enhances the load distribution and stability of the cart 1. The axle curves optimize the ground clearance of the cart 1 while also maintaining a low center of gravity, enhancing the cart's balance and maneuverability. Each of the axles 4 are connected to a set of wheels 5, which may be composed of a hard-wearing material like reinforced rubber or a like composite, allowing the navigation of various terrains with ease.

A rectangular bar 6 is connected to and protrudes perpendicularly from the front arched axle 4. This bar 6 serves as a pivotal connection point for additional components. For example, a handle 7, which facilitates a user's control over the movement and direction of the cart 1, is pivotally connected to the bar 6 by an elongate shaft. The positioning and angle of the handle 7 are calibrated to reduce strain during movement of the cart 1.

A left side dumping mechanism 8 links the bed 2 to the frame 3. This mechanism is part of a system that allows for the bilateral dumping capability of the cart 1. The mechanism 8 incorporates a series of levers, hinges, and locking features that allow the user to effortlessly tip the bed 2 to either side of the cart 1. The mechanism 8 ensures that the dumping action is smooth and controlled, safeguarding against accidental spillage and enhancing the efficiency of the unloading process.

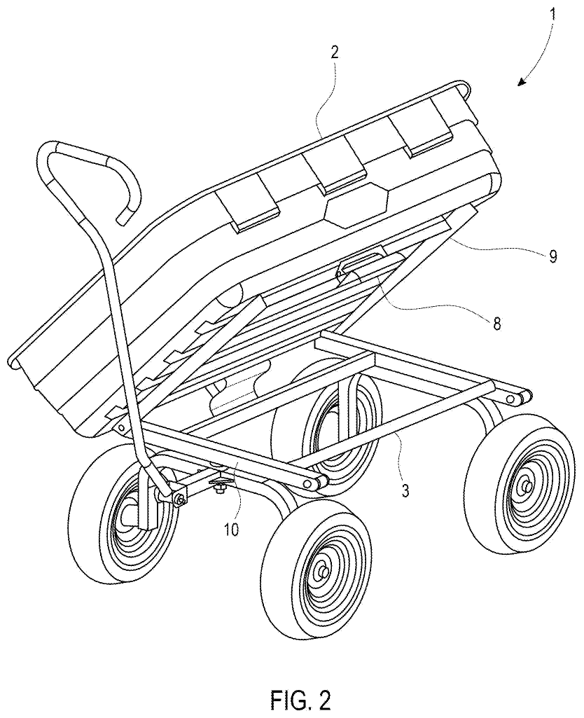

In FIG. 2, the cart 1 is shown in a right side dumping configuration, where the bed 2 is angled toward the right side of the cart 1. This angle reveals the integral components of the frame 3, which is bifurcated into a top portion 9 and a bottom portion 10. The top portion 9, which supports the bed 2, is pivotally connected to the bottom portion 10 on the right side of the frame 3. This pivotal connection allows the bed 2 to be smoothly transitioned into a tilted position, facilitating the efficient unloading of materials to the right side of the cart 1. Contrarily, a pivotal connection between the top portion 9 and the bottom portion 10 is intentionally omitted on the left side of the frame 3. This asymmetry allows the bed 2 to be lifted and tilted for right side dumping without hindrance from the left side.

The dual side dumping mechanisms of the cart, which include the left side dumping mechanism 8 and the right side dumping mechanism 11, are central to the bilateral dumping functionality of the cart 1. Particularly, in the right side dumping configuration, both the right and left sides of the top portion 9 of the frame 3 are connected to the bottom of the dumping bed 2 by the dual side dumping mechanisms.

For example, the left side of the frame's top portion 9 is pivotally connected to the bottom of the dumping bed 2 by the cart's left side dumping mechanism 8. Similarly, the right side of the frame's top portion 9 is connected to the dumping bed 2 by the cart's right side dumping mechanism 11. However, the cart's right side dumping mechanism 11 forms the connection that allows the top portion 9 and bottom portion 10 of the frame 3 to pivot with respect to one another, so the right side of the frame's top portion 9 is not pivotally connected to the dumping bed 2.

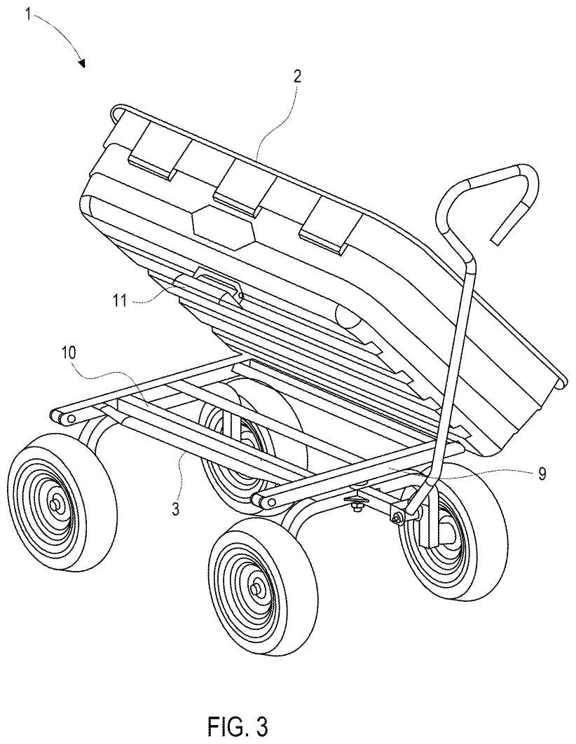

In the detailed view provided by FIG. 3, the cart 1 is captured in a left side dumping configuration, highlighting the absence of a direct pivotal connection between the right side of the dumping bed 2 and the corresponding right side of the top portion 9 of the frame 3. This specific structure enables a left side dumping configuration wherein the bed 2 can be disengaged and elevated towards the left side of the cart 1 following the release of the right side dumping mechanism 11. The act of unlocking this mechanism 11 allows the bed 2 to freely rotate about the pivotal axis with the left side of the top portion 9 of the frame 3.

The left side dumping mechanism 8, which facilitates the aforementioned rotation, also supports the weight of the bed 2 and its load during the tilting action. Similarly, the frame 3, with its top portion 9 resting on the bottom portion 10, also provides a stable base during the dumping action. For example, the top portion 9 is secured over the bottom portion 10 in a manner that maximizes contact area, thereby distributing the weight of the loaded bed 2 evenly, minimizing stress on the frame 3. This stability is critical, particularly when the cart is used on uneven ground or when the bed 2 is heavily loaded.

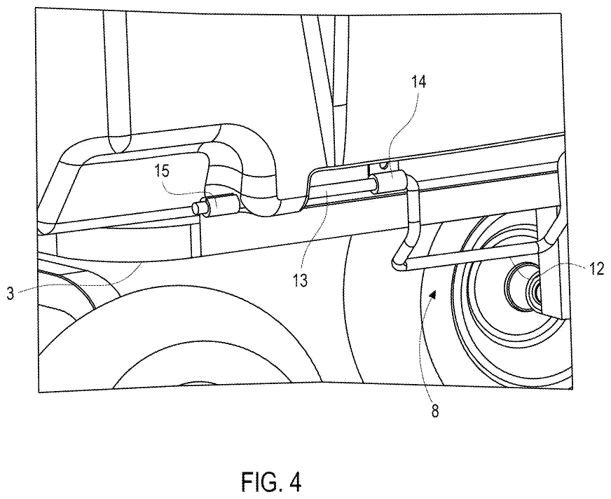

FIG. 4 offers a closer inspection of the left side dumping mechanism 8 in its secure, locked configuration. This mechanism features a handle 12 that bends underneath the frame 3, serving a critical function of maintaining the mechanism's stability, particularly in a locked configuration. The bent part of the handle 12 is affixed to the proximal end of a rod 13, which is held in place by two annular bands 14 and 15. These bands 14 and 15 are cylindrical in shape and are each characterized by a precisely defined circular aperture running the length of the cylinder, which is essential in securing the rod 13 and thus the entire mechanism 8.

The first annular band 14 is connected to the bottom of the dumping bed 2, which, in this embodiment, serves as the only point of connection to the dumping mechanism 8. The second annular band 15 is attached to the frame 3, which ensures that the rod 13 is held in a fixed lateral position, thereby stabilizing the mechanism 8 and preventing any undesirable shifting or movement during usage of the cart 1.

It should be expressly understood both the left side dumping mechanism 8 and the right side dumping mechanism utilize the same structural components, allowing both mechanisms to function similarly. Particularly, both the left and right side dumping mechanisms 8 and 11 are meticulously engineered to withstand the forces exerted during the loading and unloading of materials. The construction of the annular bands 14 and 15, possibly utilizing high-strength materials, allows them to perform their functions reliably over an extended period. The circular geometry and size of the openings is crucial, as they are designed to accommodate the rod 13 snugly, minimizing play and wear over time. The handle 12 ensures that the mechanisms can be unlocked with minimal effort while also providing a secure hold when the mechanism is in a locked configuration.

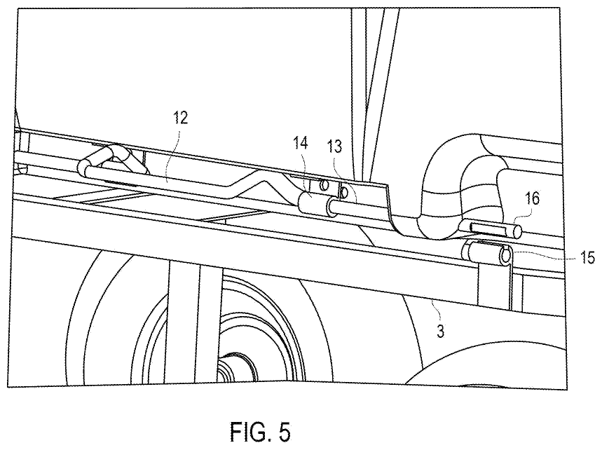

FIG. 5 delves into the unlocking sequence of the dumping mechanism, providing a perspective view of the handle 12 in a fully released position. The handle 12, when lifted, disengages from beneath the frame 3, initiating the unlocking process. This action causes a lateral rotation of the rod 13 with the annular bands 14 and 15. The direction of the rod's rotation is dependent on the side of the cart 1 the rod 13 is situated on. When viewed from the front towards the rear of the cart 1, the rod 13 for the right side dumping mechanism 11 will turn clockwise; whereas, the rod 13 for the left side dumping mechanism 8 will turn counterclockwise when viewed from the same perspective.

The maneuvering of the handle 12, when performed, leads to a deliberate rotation of approximately ninety degrees (90°). The bent portion of the handle 12 coming into contact with the dumping bed 2 prevents any further rotation past the approximate 90° mark, within ±5°. Past the point of contact between the handle 12 and the bed 2, further lifting of the handle 12 allows the distal end 16 of the rod 13 to be completely removed from the annular band 15, which is securely affixed over the frame 3. This disengagement is crucial, as it releases the bed 2, permitting it to pivot into a dumping configuration.

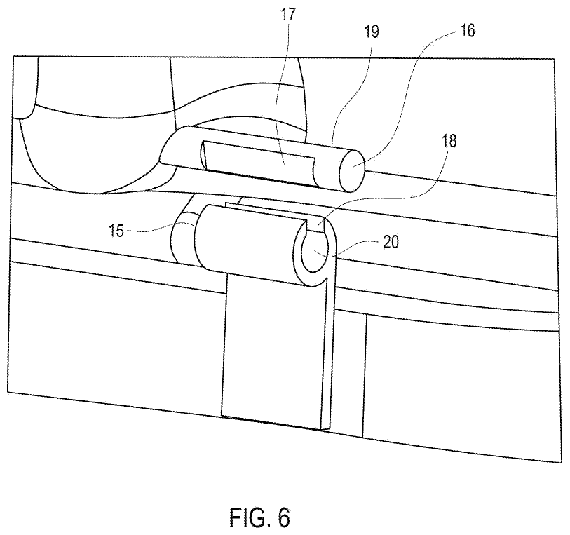

FIG. 6 provides a close up view of an embodiment of the mechanism that allows the rod's distal end 16 to be released from the annular band 15. In this embodiment, the distal end 16 defines an indentation 17 that fits through a slot 18 defined in the annular band 15. The indentation 17 is a substantially flat and is formed by a rectangular, cross-sectional slice through a side of the distal end 16. The distal end 16 also has a round side 19, which is perpendicular to the indentation 17. The width of the side of the distal end 16 with the indentation 17 is less than the diameter of round side 19, which is critical for providing a reciprocal locking and unlocking mechanism on a single rod.

The slot 18 is a lengthwise, rectangular opening formed on top of the annular band 15. The size of the slot 18 is less than the diameter of the circular aperture 20 defined through the length of the band 15. Particularly, the size of the slot 18 is equal to or greater than the width of the side distal end 16 with the indentation 17, but less than the diameter of the round side 19. This allows the side of the distal end 16 with the indentation 17 to pass through the slot 18, while preventing the round side 19 from doing the same thing.

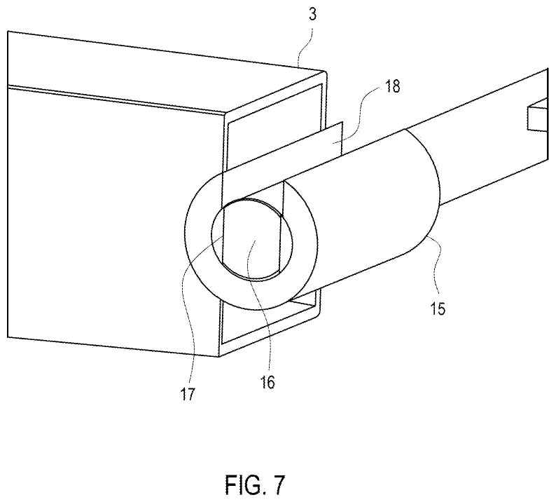

If the distal end 16 is inside the annular band 15 and the indentation 17 is parallel with the slot 18, then the dumping mechanism is in an unlocked configuration (FIG. 7). This is the case because the size of the slot 18 is equal to or greater than the width of the side of the distal end 16 with the indentation 17. Contrarily, if the distal end 16 is inside the annular band 15 and the indentation 17 is not parallel with the slot 18, then the dumping mechanism is in a locked configuration. This is the case because the size of the slot 18 is less than the diameter of the rounded side 19 of the distal end 16.

FIG. 7 provides an example of the dumping mechanism in an unlocked configuration, while also providing a closer perspective of one embodiment where the annular band 15 is uniquely placed within the structure of the frame 3, instead of over it. The internal embedding of the annular band 15 is driven by structural and functional considerations, including, but not limited to, compactness and protection of the annular band 15 and distal end 16 from external elements.

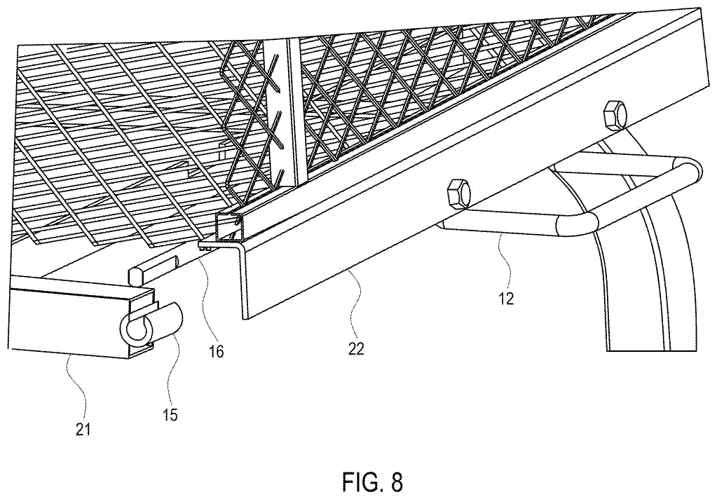

FIG. 8 illustrates another embodiment of a cart with an annular band 15 that is positioned internally within a frame 21. The frame 21 supports a dumping cage 22, which prevents over-rotation of the handle 12. Specifically, the bottom of the dumping cage 22 serves as a physical limit to the rotation of the handle, ensuring that the distal end 16 of the handle 12 aligns precisely with the slot in the annular band 15. The precision of the alignment is crucial for the ease of disconnection of the dumping cage 22 from the frame 21, as the indentation(s) on the distal end must be parallel with the slot of the annular band 15.

In this embodiment, the dumping cage 22 is constructed from a network of interconnected bars or mesh, which provides secure containment for materials while allowing for visibility and ventilation. This offers versatility for the usage of the cart 1 in a wider range of applications, from agricultural to industrial settings.

While several variations of the present disclosure have been illustrated by way of example in preferred or particular embodiments, it is apparent that further embodiments could be developed within the spirit and scope of the present disclosure, or the inventive concept thereof. However, it is to be expressly understood that such modifications and adaptations are within the spirit and scope of the present disclosure, and are inclusive, but not limited to the following appended claims as set forth.

What is claimed is:

1. A bilateral dumping cart comprising:
a front, a rear, a left side, and a right side;
a bed supported by a frame;
a pair of axles connected to the frame;
wherein each one of the pair of axles is connected to a set of wheels; and
a dumping mechanism positioned on at least one of the left side or the right side of the bilateral dumping cart.

2. The bilateral dumping cart of claim 1, wherein the bed is pivotally connected to the frame by the dumping mechanism.

3. The bilateral dumping cart of claim 1 wherein the dumping mechanism further comprises a handle that when lifted causes the side dumping mechanism to transition from the locked configuration to an unlocked configuration.

4. The bilateral dumping cart of claim 1 wherein the dumping mechanism further comprises a rod that extends through an annular band affixed to at least one of the bed or the frame.

5. The bilateral dumping cart of claim 4 wherein the annular band defines a circular aperture through the length of the cylinder to hold the rod in place.

6. The bilateral dumping cart of claim 1 wherein the frame comprises a top portion and a bottom portion.

7. The bilateral dumping cart of claim 6, wherein the top portion is pivotally connected to the bottom portion on at least one of the left side or the right side.

8. The bilateral dumping cart of claim 1, wherein at least one of the pair of axles is arched to provide ground clearance.

9. The bilateral dumping cart of claim 1, further comprising a rectangular bar extending perpendicularly from one of the pair of axles proximate the front.

10. The bilateral dumping cart of claim 9 further comprising a pull handle pivotally connected to the rectangular bar by an elongate shaft.

11. The bilateral dumping cart of claim 1 further comprising two dumping mechanisms, one of the two dumping mechanisms located on the left side and one of the two dumping mechanism located on the right side.

12. The bilateral dumping cart of claim 11 wherein the one of the two dumping mechanisms on the left side is configured to tilt the bed towards the right side when unlocked.

13. The bilateral dumping cart of claim 11 wherein the one of the two dumping mechanisms on the right side is configured to tilt the bed towards the left side when unlocked.

14. A side dumping mechanism comprising:
a handle connected to a rod;
the rod extending through a first annular band and a second annular band;
wherein the side dumping mechanism is connected to a bilateral dumping cart comprising a frame.

15. The side dumping mechanism of claim 14 wherein the handle is bent under the frame when in a locked configuration.

16. The side dumping mechanism of claim 14 wherein the first annular band is connected to at least one of a dumping bed or a dumping cage of the bilateral dumping cart.

17. The side dumping mechanism of claim 14 wherein the second annular band is affixed to the frame of the bilateral dumping cart.

18. The side dumping mechanism of claim 14 wherein the rod comprises a proximal and a distal end, the proximal end of the rod connected to the handle.

19. The side dumping mechanism of claim 18 wherein the distal end of the rod comprises an indentation, the distal end located within the second annular band.

20. The side dumping mechanism of claim 19 wherein the second annular band further comprises a slot, wherein the indentation is perpendicular to the slot in a locked configuration and parallel to the slot in an unlocked configuration.
